(19) United States
(12) Patent Application Publication
(10) Pub. No.: US 2025/0321568 A1
(43) Pub. Date: Oct. 16, 2025

(54) INFORMATION PROCESSING APPARATUS, INFORMATION PROCESSING METHOD, AND STORAGE MEDIUM

(71) Applicant: Tokyo Electron Limited, Tokyo (JP)

(72) Inventors: Huizhen BU, Tokyo (JP); Atsushi SHIGENOBU, Yamanashi (JP); Yuka NAKASATO, Yamanashi (JP); Tetsushi YANO, Yamanashi (JP); Masahiro YANAGISAWA, Yamanashi (JP)

(21) Appl. No.: 19/173,038

(22) Filed: Apr. 8, 2025

(30) Foreign Application Priority Data
Apr. 16, 2024 (JP) 2024-066178

(51) Int. Cl. G05B 19/418

(52) U.S. Cl. CPC G05B 19/4183; G05B 2219/32191; G05B 2219/45031

(57) ABSTRACT

An information processing apparatus includes an acquisition unit that acquires sensor data indicating a sensor value measured by one or more sensors provided in a substrate processing apparatus that performs a process including one or more steps, a statistical processing unit that calculates a statistical value of the sensor value for each step based on the sensor data, and an analysis unit that analyzes the process based on processed data including the statistical value for each step.

### CROSS-REFERENCE TO RELATED APPLICATIONS

This application is based on and claims priority from Japanese Patent Application No. 2024-066178, filed on Apr. 16, 2024, with the Japan Patent Office, the disclosure of which is incorporated herein in its entirety by reference.

### TECHNICAL FIELD

The present disclosure relates to an information processing apparatus, an information processing method, and a storage medium.

### BACKGROUND

A technology for analyzing sensor data output from a substrate processing apparatus is known. For example, Japanese Patent Laid-Open Publication No. 2024-002710 discloses an information processing apparatus that analyzes the similarity of a plurality of pieces of time-series data output from a substrate processing apparatus that performs a processing according to the same sequence, using a dynamic time stretching method, and outputs analysis results based on the difference in time-series data.

### SUMMARY

According to an aspect of the present disclosure, an information processing apparatus includes an acquisition unit that acquires sensor data indicating a sensor value measured by one or more sensors provided in a substrate processing apparatus that performs a process including one or more steps, a statistical processing unit that calculates a statistical value of the sensor value for each step based on the sensor data, and an analysis unit that analyzes the process based on processed data including the statistical value for each step.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example of an overall configuration of a substrate processing system.

FIG. 2 is a schematic cross-sectional view illustrating an example of a substrate processing apparatus.

FIG. 3 is a block diagram illustrating an example of a hardware configuration of a computer.

FIG. 4 is a block diagram illustrating an example of a functional configuration of an analysis apparatus.

FIG. 5 is a diagram illustrating an example of processed data.

FIG. 6 is a flowchart illustrating an example of an analysis method.

FIG. 7 is a diagram illustrating an example of segmentation.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for implementing the present disclosure will be described with reference to the drawings. In each drawing, identical reference numerals are given to identical components, and redundant descriptions may be omitted.

### EMBODIMENT

One embodiment of the present disclosure relates to a substrate processing system including a substrate processing apparatus for processing a substrate, which is an example of a processing target. In the present embodiment, the substrate processing apparatus thermally processes a semiconductor wafer, which is an example of a substrate, inside a processing container. Further, the substrate processing system includes an analysis apparatus that analyzes sensor data indicating sensor values measured by sensors provided in the substrate processing apparatus.

The substrate processing apparatus is provided with one or more sensors for measuring the state of the substrate processing apparatus. When the substrate processing apparatus executes a process for processing a substrate, the sensors provided in the substrate processing apparatus measure predetermined sensor values at predetermined time intervals. Time-series data of the sensor values measured by the respective sensors is stored in a storage device included in the substrate processing apparatus, or in a storage device connected to the substrate processing apparatus via a network. The time-series data of the sensor values is also referred to as “trace data.” The trace data is an example of sensor data.

The trace data is utilized for the analysis of a process executed by the substrate processing apparatus. Examples of analysis types may include anomaly detection, variation factor analysis, and equipment difference analysis. Anomaly detection is used to detect abnormalities occurring in the substrate processing apparatus. Variation factor analysis is used to analyze factors causing variations in process results for each process in a single substrate processing apparatus. Equipment difference analysis is used to analyze the difference in equipment states when a plurality of substrate processing apparatuses execute the same process.

When performing an analysis, it is necessary to perform various types of preprocessing on raw trace data to convert it into an analyzable state. However, the type or execution order of required preprocessing depends on each analysis. Therefore, the preprocessing needs to be adjusted each time an analysis is executed. Further, the preprocessing performed for one type of analysis may not be reused for other analyses. Consequently, the necessity of permanently preserving trace data recorded at a high frequency leads to an increase in storage capacity. Further, since a preprocessing is performed on trace data each time an analysis is performed, a significant computational load is required. Furthermore, commonly used data preprocessing methods may not ensure sufficient analysis accuracy since trace data generated by the substrate processing apparatus exhibits unique characteristics specific to each process.

The present embodiment aims to reduce the computational load required for process analysis. Therefore, in the present embodiment, statistical values of sensor values for each step are calculated based on sensor data indicating the sensor values measured by the sensors provided in the substrate processing apparatus, and a process is analyzed based on processed data including the statistical values for each step.

In one aspect, according to the present embodiment, the computational load required for process analysis may be reduced since processed data may be reused in various analyses. In another aspect, according to the present embodiment, the accuracy of process analysis is improved since preprocessing parameters are determined based on domain knowledge.

### <System Configuration>

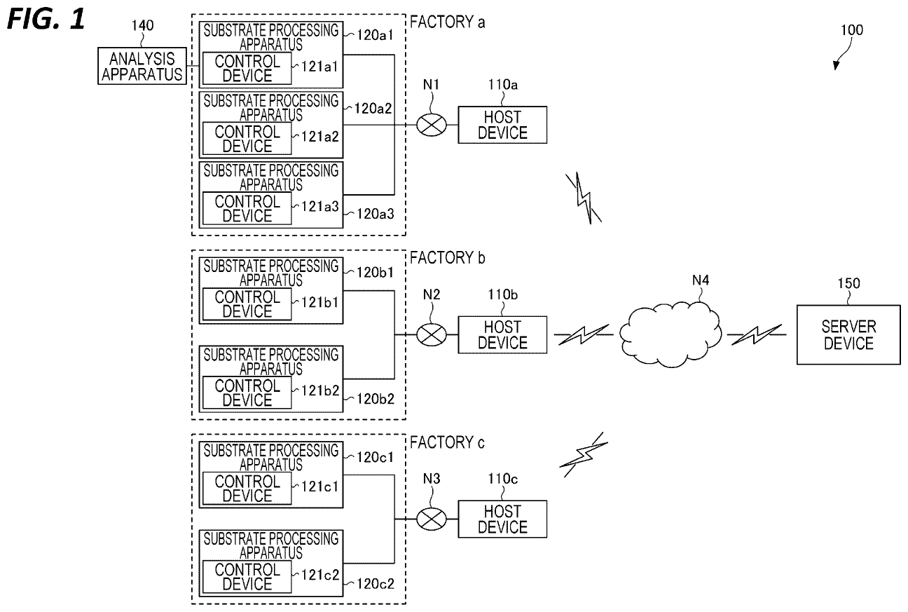

An overall configuration of a substrate processing system according to the present embodiment will be described with reference to FIG. 1. FIG. 1 is a block diagram illustrating an example of an overall configuration of a substrate processing system.

As illustrated in FIG. 1, the substrate processing system 100 includes substrate processing apparatuses 120a1 to 120a3 and control devices 121a1 to 121a3 in a factory a. The substrate processing apparatuses 120a1 to 120a3 and the control devices 121al to 121a3 are connected in a wired or wireless manner.

Further, the substrate processing system 100 includes substrate processing apparatuses 120b1 and 120b2 and control devices 121b1 and 121b2 in a factory b. The substrate processing apparatuses 120b1 and 120b2 and the control devices 121b1 and 121b2 are connected in a wired or wireless manner.

Further, the substrate processing system 100 includes substrate processing apparatuses 120c1 and 120c2 and control devices 121c1 and 121c2 in a factory c. The substrate processing apparatuses 120c1 and 120c2 and the control devices 121cl and 121c2 are connected in a wired or wireless manner.

The substrate processing apparatuses 120a1 to 120a3, the substrate processing apparatuses 120b1 and 120b2, and the substrate processing apparatuses 120c1 and 120c2 are connected to host apparatuses 110a, 110b, and 110c via networks N1 to N3, respectively. Each substrate processing apparatus executes substrate processing under the control of each control device based on instructions from the host apparatuses 110a, 110b, and 110c. The host apparatuses 110a, 110b, and 110c are connected to a server apparatus 150 via a network N4 such as the Internet.

In the following description, the substrate processing apparatuses 120al to 120a3, 120b1, 120b2, 120c1, and 120c2 are collectively referred to as “substrate processing apparatus 120.” Further, the control devices 121a1 to 121a3, 121b1, 121b2, 121c1, and 121c2 are collectively referred to as a “control device 121.” The host apparatuses 110a, 110b, and 110c are collectively referred to as a “host apparatus 110.”

The substrate processing apparatuses 120a1 to 120a3, the substrate processing apparatuses 120b1 and 120b2, and the substrate processing apparatuses 120c1 and 120c2 are assumed to individually accumulate a wide variety of data, where they manage, inside respective apparatuses thereof.

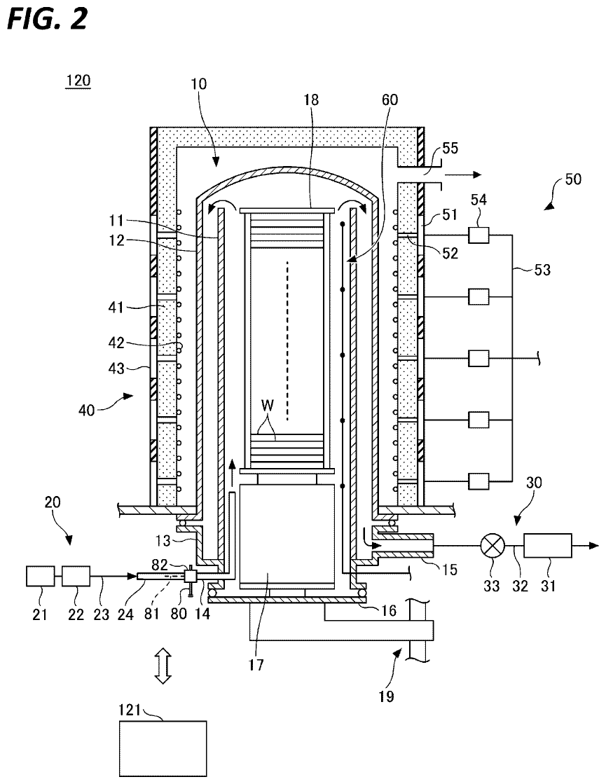

An analysis apparatus 140 is connected to the substrate processing apparatus 120 including the substrate processing apparatus 120a1, thereby continuously acquiring accumulated data stored in each substrate processing apparatus 120. FIG. 2 illustrates an example where the analysis apparatus 140 is connected to the substrate processing apparatus 120a1, but is not limited thereto. Hereinafter, in the present embodiment, details of a case where the analysis apparatus 140 is connected to the substrate processing apparatus 120al will be described.

It goes without saying that the substrate processing system 100 illustrated in FIG. 1 is merely an example, and various system configuration examples may be employed depending on the application and purpose. The classification of components such as the host apparatus 110, substrate processing apparatus 120, control apparatus 121, analysis apparatus 140, and server apparatus 150 illustrated in FIG. 1 is also merely an example. For example, the number of factories, the number of host apparatuses 110, the number of substrate processing apparatuses 120, the number of control devices 121, and the number of analysis apparatuses 140 are not limited to the example.

For example, the substrate processing system 100 may have various configurations, such as an integrated configuration in which at least two of the substrate processing apparatus 120, control device 121, host apparatus 110, analysis apparatus 140, and server apparatus 150 are combined, or a further subdivided configuration. For example, the control device 121 may be configured to collectively control a plurality of substrate processing apparatuses 120, may be provided on a one-to-one basis for each substrate processing apparatus 120, or may be integrated with the substrate processing apparatus 120.

The analysis apparatus 140 may be implemented by the host apparatus 110, or may be implemented by the server apparatus 150. In this case, the analysis apparatus 140 becomes unnecessary. Further, the analysis apparatus 140 may be implemented by the control device 121. The analysis apparatus 140 may be implemented by a control device that collectively controls a plurality of control devices 121.

### <Substrate Processing Apparatus>

An example of the substrate processing apparatus according to the present embodiment will be described with reference to FIG. 2. FIG. 2 is a schematic cross-sectional view illustrating a vertical heat treatment apparatus, which is an example of a substrate processing apparatus.

The vertical heat treatment apparatus 120 according to the present embodiment is a substrate processing apparatus that accommodates a large number of semiconductor wafers W, which are an example of a processing target, at a time and performs heat treatment such as oxidation, diffusion, and reduced-pressure chemical vapor deposition (CVD). As illustrated in FIG. 2, the vertical heat treatment apparatus 120 includes components such as a processing container 10, a gas supply 20, an exhauster 30, a heating mechanism 40, a cooler 50, and the control device 121.

The processing container 10 has a substantially cylindrical shape. The processing container 10 includes an inner tube 11, an outer tube 12, a manifold 13, an injector 14, a gas outlet 15, a lid 16, and others. The inner tube 11 has a substantially cylindrical shape, and the outer tube 12 has a substantially cylindrical shape with a ceiling. Both the inner tube 11 and the outer tube 12 form a dual tube structure. The inner and outer tubes 11 and 12 are formed of a heat-resistant material such as, for example, quartz.

The manifold 13 has a substantially cylindrical shape. The manifold 13 supports the lower ends of the inner tube 11 and the outer tube 12. The manifold 13 is formed of, for example, stainless steel. The injector 14 passes through the manifold 13 to extend horizontally inside the inner tube 11, and is then bent into an L-shape inside the inner tube 11 to extend upward. The injector 14 has a base connected to a gas introduction pipe 24 and a tip thereof is open. The injector 14 discharges a processing gas (hereinafter, simply referred to as “gas”) introduced through the gas introduction pipe 24 into the inner tube 11 from a tip opening thereof. There may be a plurality of injectors 14.

The gas outlet 15 is formed in the manifold 13. The processing gas is discharged through the gas outlet 15 by the exhauster 30. The lid 16 airtightly seals an opening at the lower end of the manifold 13. The lid 16 is formed of, for example, stainless steel. A wafer boat (substrate holder) 18 is disposed on the lid 16 via a heat reservoir 17. The heat reservoir 17 and the wafer boat 18 are formed of a heat-resistant material such as, for example, quartz.

The wafer boat 18 holds a plurality of semiconductor wafers W approximately horizontally at predetermined intervals in the vertical direction. The wafer boat 18 is loaded into and accommodated in the processing container 10 when a lifting mechanism 19 raises the lid 16. The wafer boat 18 is unloaded from the processing container 10 when the lifting mechanism 19 lowers the lid 16.

The gas supply 20 includes a gas source 21, an integrated gas system (IGS) 22, an external pipe 23, and the gas introduction pipe 24. The gas source 21 is a supply source of the processing gas and includes, for example, a film forming gas source, a cleaning gas source, and a purge gas source. The IGS 22 is an integrated circuit of gas pipes, where pipe groups connected respectively to, for example, the film forming gas source, cleaning gas source, and purge gas source of the gas source 21 are integrated. A flow-rate controller is provided inside the IGS 22 to control the flow rate of gas flowing through each pipe. The flow-rate controller includes, for example, a mass flow controller and an on-off valve.

The IGS 22 is connected to the external pipe 23. The external pipe 23 is connected to the gas introduction pipe 24. A heating wire (not illustrated) is wound around the outer periphery of the external pipe 23 to heat the external pipe 23. The gas introduction pipe 24 is connected to the processing container 10 to introduce a gas to the inside of the processing container 10. In other words, the processing gas from the gas source 21 is controlled for the flow rate thereof by the flow-rate controller inside the IGS 22, is heated while flowing through the external pipe 23 and is then directed into the gas introduction pipe 24. The processing gas is supplied from the gas introduction pipe 24 into the processing container 10 through the injector 14. The injector 14 functions as a gas inlet of the processing container 10.

A gas pipe joint 82 connected to the gas introduction pipe 24 is provided near the gas inlet of the processing container 10. A temperature sensor 80 is configured to pass through the joint 82. The temperature sensor 80 is configured to measure the temperature of gas inside the gas introduction pipe 24. The temperature sensor 80 transmits the measured temperature to the control device 121. Further, a second heater 81 is arranged inside the gas introduction pipe 24. The second heater 81 is configured to heat the gas inside the gas introduction pipe 24.

The exhauster 30 includes an exhaust device 31, an exhaust pipe 32, and a pressure controller 33. The exhaust device 31 is, for example, a vacuum pump such as a dry pump or turbo molecular pump. The pressure controller 33 is interposed in the exhaust pipe 32 and controls the pressure inside the processing container 10 by adjusting the conductance of the exhaust pipe 32. The pressure controller 33 is, for example, an automatic pressure control valve.

The heating mechanism 40 includes a heat insulator 41, a first heater 42, and an outer shell 43. The heat insulator 41 has a substantially cylindrical shape and is provided around the outer tube 12. The heat insulator 41 is formed of silica and alumina as main components. The first heater 42 has a linear shape and is provided in a spiral or meandering shape on the inner periphery of the heat insulator 41. The first heater 42 is configured to enable temperature control in a plurality of zones divided in the height direction of the processing container 10. The outer shell 43 is provided to cover the outer periphery of the heat insulator 41. The outer shell 43 serves to maintain the shape of the heat insulator 41 and to reinforce the heat insulator 41. The outer shell 43 is formed of a metal such as stainless steel. Further, to prevent the influence of heat on the exterior of the heating mechanism 40, a water cooling jacket may be provided on the outer periphery of the outer shell 43. The heating mechanism 40 heats the inside of the processing container 10 through the heat generation of the first heater 42.

The cooler 50 supplies a cooling fluid toward the processing container 10 to cool the semiconductor wafer W inside the processing container 10. The cooling fluid may be, for example, air. The cooler 50 supplies the cooling fluid toward the processing container 10, for example, when rapidly cooling the semiconductor wafer W after heat treatment. The cooler 50 includes a fluid flow path 51, an ejection hole 52, a distribution flow path 53, a flow-rate adjuster 54, and a heat discharge port 55.

A plurality of fluid flow paths 51 is formed in the height direction between the heat insulator 41 and the outer shell 43. The fluid flow paths 51 are formed, for example, in the circumferential direction outside the heat insulator 41. The ejection hole 52 is formed to pass through the heat insulator 41 from each fluid flow path 51, thus ejecting the cooling fluid into the space between the outer tube 12 and the heat insulator 41. The distribution flow path 53 is provided outside the outer shell 43 to distribute and supply the cooling fluid to each fluid flow path 51. The flow-rate adjuster 54 is interposed in the distribution flow path 53 to adjust the flow rate of the cooling fluid supplied to the fluid flow path 51.

The heat discharge port 55 is provided above a plurality of ejection holes 52 to discharge the cooling fluid, supplied to the space between the outer tube 12 and the heat insulator 41, to the outside of the processing container 10. The cooling fluid discharged to the outside of the processing container 10 is cooled, for example, by a heat exchanger and then supplied again to the distribution flow path 53. However, the cooling fluid discharged to the outside of the processing container 10 may be discharged without being reused.

A temperature sensor 60 detects the temperature inside the processing container 10. The temperature sensor 60 is provided, for example, inside the inner tube 11. However, the temperature sensor 60 may be provided at a position where it may detect the temperature inside the processing container 10. For example, the temperature sensor 60 may be provided in the space between the inner tube 11 and the outer tube 12. The temperature sensor 60 includes, for example, a plurality of temperature measuring components provided at different positions in the height direction corresponding to the plurality of zones. The plurality of temperature measuring components may be, for example, thermocouples or temperature measuring resistors. The temperature sensor 60 transmits the temperatures detected by the plurality of temperature measuring components to the control device 121.

The control device 121 controls the operation of the vertical heat treatment apparatus 120, thereby controlling a semiconductor process executed by the vertical heat treatment apparatus 120. The control device 121 may be, for example, a computer.

### <Computer>

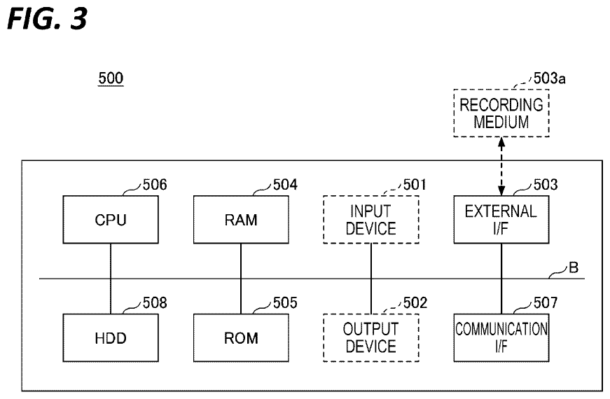

The host apparatus 110, control device 121, analysis apparatus 140, and server apparatus 150 included in the substrate processing system 100 as illustrated in FIG. 1 are implemented, for example, by a computer having a hardware configuration as illustrated in FIG. 3. FIG. 3 is a block diagram illustrating an example of a hardware configuration of a computer.

As illustrated in FIG. 3, the computer 500 includes an input device 501, an output device 502, an external interface (I/F) 503, a random access memory (RAM) 504, a read only memory (ROM) 505, a central processing unit (CPU) 506, a communication I/F 507, and a hard disk drive (HDD) 508, among others, each of which is interconnected via a bus B. The input device 501 and the output device 502 may be connected and used as needed.

The input device 501 includes devices such as a keyboard, a mouse, and a touch panel, which are used by, for example, an operator to input each operation signal. The output device 502 is a display or similar device, which displays processing results by the computer 500. The communication I/F 507 is an interface that connects the computer 500 to a network. The HDD 508 is an example of a non-volatile storage device that stores programs and data.

The external I/F 503 is an interface to an external device. The computer 500 may read from and/or write to a recording medium 503a such as a secure digital (SD) memory card via the external I/F 503. The ROM 505 is an example of a non-volatile semiconductor memory (storage device) that stores programs and data. The RAM 504 is an example of a volatile semiconductor memory (storage device) that temporarily holds programs and data.

The CPU 506 is an arithmetic unit that reads programs and data from storage devices such as the ROM 505 and the HDD 508 onto the RAM 504 and executes processing to implement the overall control and functions of the computer 500.

### <Function Configuration>

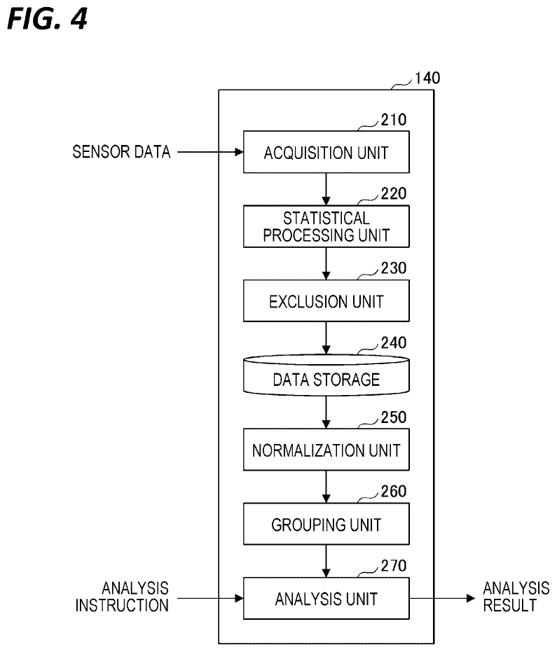

A functional configuration of an analysis device according to the present embodiment will be described with reference to FIG. 4. FIG. 4 is a block diagram illustrating an example of a functional configuration of an analysis apparatus.

As illustrated in FIG. 4, the analysis apparatus 140 includes an acquisition unit 210, a statistical processing unit 220, an exclusion unit 230, a data storage 240, a normalization unit 250, a grouping unit 260, and an analysis unit 270. The analysis apparatus 140 functions as the acquisition unit 210, the statistical processing unit 220, the exclusion unit 230, the data storage 240, the normalization unit 250, the grouping unit 260, and the analysis unit 270 when a pre-installed analysis program is executed.

The acquisition unit 210, statistical processing unit 220, exclusion unit 230, normalization unit 250, grouping unit 260, and analysis unit 270 are implemented, for example, by the CPU 506 illustrated in FIG. 3 executing a program loaded onto the RAM 504. The data storage 240 is implemented, for example, by the RAM 504 or the HDD 508 as illustrated in FIG. 3.

The acquisition unit 210 acquires trace data generated by the substrate processing apparatus 120. The trace data is time-series data indicating sensor values measured by one or more sensors provided in the substrate processing apparatus 120. The trace data may include a plurality of time series datasets each indicating sensor values measured by each of a plurality of sensors.

The trace data may include time-series data of sensor values measured when the substrate processing apparatus 120 executes a process for processing a processing target. The process may include at least one step. The trace data may include time-series data of sensor values measured when the substrate processing apparatus 120 executes a plurality of processes. The trace data may be, for example, a single time-series dataset recorded over a plurality of processes, or may be a plurality of pieces of time-series data recorded each time a process is executed.

The statistical processing unit 220 calculates statistical values of sensor values for each step included in a process based on the trace data acquired by the acquisition unit 210. The statistical processing unit 220 generates processed data including the statistical values of sensor values. The statistical processing unit 220 may also calculate the processing time for each step along with the statistical values for each step and include them in the processed data.

The statistical processing unit 220 may exclude sensor values related to steps with short processing times from the trace data. For example, the statistical processing unit 220 may calculate the processing time of each step included in the trace data and may exclude sensor values related to steps with processing times less than a predefined threshold from the trace data.

The threshold for the processing time may be specified by the user of the analysis apparatus 140. The threshold may be stored in a storage such as, for example, the HDD 508 of the analysis apparatus 140. The threshold may be determined based on domain knowledge. For example, the threshold may be determined by an engineer with the behavior knowledge of the substrate processing apparatus 120. The threshold may be set to, for example, approximately 0.1 seconds or 1 second.

The statistical processing unit 220 may calculate a plurality of predefined statistical values. The types of statistical value may be determined based on domain knowledge. The types of statistical values may include at least one of the maximum value, minimum value, mean value, standard deviation (e.g., 36), mode value, or slope (slope of the regression line). In the present embodiment, as an example, a configuration in which the statistical processing unit 220 calculates the maximum value, minimum value, mean value, and standard deviation will be described.

The statistical processing unit 220 may calculate statistical values for each step included in the trace data, regardless of the type of recipe or step included in the process. An example of the type of recipe or step may include a main recipe, a sub recipe, a main step, or a sub step.

The exclusion unit 230 excludes statistical values based on trace data that does not satisfy a predefined variation range criterion, among the trace data acquired by the acquisition unit 210, from the processed data generated by the statistical processing unit 220. For example, the exclusion unit 230 may exclude statistical values, calculated based on trace data that does not satisfy a predefined fixed value criterion, from the processed data. The exclusion unit 230 may also exclude statistical values, calculated based on trace data that does not satisfy a predefined minute variation criterion, from the processed data.

The fixed value criterion may indicate that the variation range of sensor values included in the trace data is equal to or greater than a predefined threshold. The variation range of sensor values is the difference between the maximum value and minimum value among sensor values included in the trace data. The threshold for the fixed value criterion may be an extremely small value such as approximately 10 to the power of −6.

The minute variation criterion may indicate that the variation range of sensor values included in the trace data is equal to or greater than a predefined threshold. The threshold for the minute variation criterion may be a value obtained by multiplying the resolution of a sensor by a predefined threshold adjustment coefficient. The resolution of a sensor refers to the minimum value measurable by the sensor. The threshold adjustment coefficient may be determined based on domain knowledge. The threshold adjustment coefficient may be determined according to the model of the substrate processing apparatus 120. In other words, the same threshold adjustment coefficient may be used for the substrate processing apparatus 120 of the same type.

The data storage 240 stores processed data. The processed data includes the statistical values for each step calculated by the statistical processing unit 220. When the trace data includes sensor values measured by a plurality of sensors, the processed data may include statistical values for each combination of sensors and steps.

The data storage 240 may accumulate processed data on a per-process basis. In other words, the data storage 240 may store the processed data on a per-process basis in a time-series arrangement. When new processed data is generated by processing trace data related to a newly executed process, the data storage 240 may add the new processed data to the end of already stored processed data.

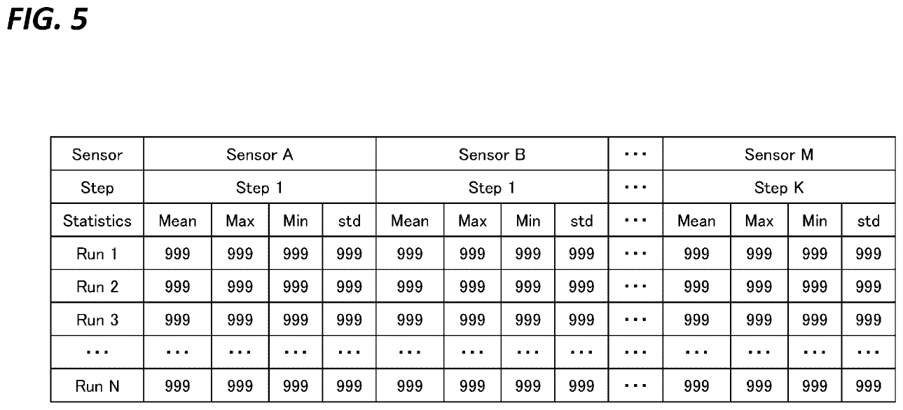

FIG. 5 is a diagram illustrating an example of processed data. As illustrated in FIG. 5, the processed data includes data items indicating four statistical values (statistics) for each combination of sensors and steps. Meanwhile, “Mean” represents the mean value, “Max” represents the maximum value, “Min” represents the minimum value, and “std” represents the standard deviation.

FIG. 5 illustrates an example of processed data when the substrate processing apparatus 120, equipped with M sensors, executes a process including K steps. Further, FIG. 5 illustrates an example of processed data after the substrate processing apparatus 120 has executed the process N times. Meanwhile, “Run” is a process execution unit that refers to a single execution of the entire process as specified in a process recipe.

The normalization unit 250 normalizes the processed data read from the data storage 240. The normalization unit 250 may normalize the processed data using a method corresponding to the analysis specified by the user.

When the analysis specified by the user is equipment difference analysis, the normalization unit 250 normalizes the processed data using a normalization method specialized for equipment difference analysis. The normalization method may be based on reproducibility between processes. Specifically, in the normalization method, the processed data is divided by a normalization coefficient obtained by converting the weighted average of the variance of the processed data into the standard deviation.

The normalization method specialized for equipment difference analysis will be described in more detail. In this normalization method, normalization is performed using different methods depending on the number of process executions included in the trace data.

When the number of process executions included in the trace data is less than 2 at most, each sensor value is divided by 10 to the power of −n. Here, “n” is the minimum decimal place of each sensor value.

When the number of process executions included in the trace data is equal to or greater than 2, first, the variance of each sensor value is calculated in the trace data in which the number of process executions is 2 or more. Next, the weighted average of the variance is calculated based on the number of process executions. Specifically, Equation (1) is calculated.

$${σ}^{2} = \frac{1}{N} {\sum }_{k = 1}^{n} {N}_{k} * {σ}_{k}^{2} \qquad [ Equation 1 ]$$

However, σₖ² is the unbiased variance of the k^{th} trace data, and Nₖ is the number of data included in the k^{th} trace data, n is the number of trace data, and N is the total number of data included in the trace data.

The weighted average of the variance σ² calculated by Equation (1) is converted into the standard deviation, and the standard deviation is defined as the normalization coefficient σ. Then, each sensor value included in the trace data is divided by the normalization coefficient σ.

When the analysis process specified by the user is an analysis other than equipment difference analysis, the normalization unit 250 normalizes processed data. Normalization is a method of transforming data so that the average becomes 0 and the variance becomes 1. The normalization method used for analyses other than equipment difference analysis is not limited thereto, but may be any known method used in data analysis.

The grouping unit 260 groups a plurality of sensors provided in the substrate processing apparatus 120. In other words, the grouping unit 260 classifies a plurality of sensors into a plurality of groups. The normalization unit 250 may group a plurality of sensors using a method corresponding to the analysis specified by the user. The grouping unit 260 may not be necessary, and sensor grouping may be omitted.

For example, the grouping unit 260 may group a plurality of sensors based on the correlation between processed data. Specifically, the grouping unit 260 may calculate a correlation coefficient between processed data for all combinations including two sensors among the plurality of sensors, and may classify sensors with a correlation coefficient equal to or greater than a predefined threshold into the same group.

For example, the grouping unit 260 may classify a plurality of sensors into predefined groups. The groups may be determined based on domain knowledge. For example, sensors that are likely to have a physicochemical correlation between the sensors based on design information of the substrate processing apparatus 120 may be classified into the same group. The group may be determined according to the model of the substrate processing apparatus 120. In other words, in the substrate processing apparatus 120 of the same type, each sensor may be classified into the same group.

The analysis unit 270 analyzes the process executed by the substrate processing apparatus 120 based on the processed data read from the data storage 240. The analysis unit 270 may accept an analysis request from the user. The analysis request may contain information indicating an analysis and information indicating an analysis target. The information indicating the analysis target may contain at least one of a step or a sensor. The analysis target step may include a plurality of steps. The plurality of steps may be specified per process or per recipe. The analysis target sensor may include a plurality of sensors. The plurality of sensors may be specified by a group.

When the analysis target sensors are specified by a group, the analysis unit 270 may acquire statistical values of sensor values measured by the sensors classified into the group from the processed data, and may analyze the process based on the representative value of statistical values for each group. The analysis unit 270 may calculate the representative value of statistical values for each group to analyze a variation within or between groups. The analysis unit 270 may construct a model used for an analysis based on the representative value of statistical values for each group. The representative value may include, for example, the mean value, mode value, median value, maximum value, and minimum value.

The analysis unit 270 reads the processed data related to the analysis target specified in the analysis request from the data storage 240, and executes the analysis specified by the user for the read processed data. The analysis unit 270 outputs analysis results indicating the outcome of analysis. For example, the analysis unit 270 may display the analysis results on the output device 502 connected to the analysis apparatus 140.

### <Processing Sequence>

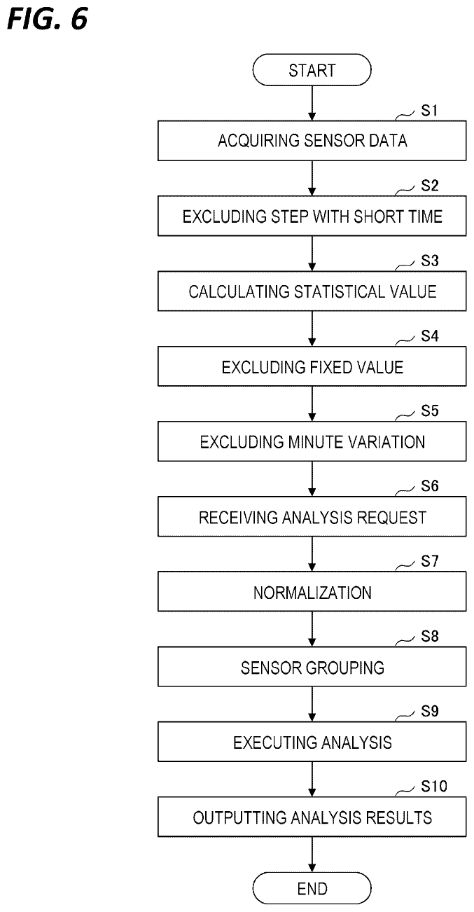

An analysis method executed by the substrate processing system 100 according to the present embodiment will be described with reference to FIG. 6. FIG. 6 is a flowchart illustrating an example of an analysis method.

In step S1, the acquisition unit 210 of the analysis apparatus 140 acquires trace data generated by the substrate processing apparatus 120. The acquisition unit 210 may acquire trace data indicating sensor values measured during the execution of a process each time the substrate processing apparatus 120 executes the process. The acquisition unit 210 sends the acquired trace data to the statistical processing unit 220 and the exclusion unit 230.

In step S2, the statistical processing unit 220 of the analysis apparatus 140 receives the trace data from the acquisition unit 210. The statistical processing unit 220 calculates the processing time for each step included in the trace data. The statistical processing unit 220 determines whether the processing time for each step is less than a predefined threshold. When the processing time is less than the threshold, the statistical processing unit 220 excludes sensor values related to that step from the trace data.

In step S3, the statistical processing unit 220 of the analysis apparatus 140 calculates statistical values of sensor values for each step included in the trace data. In the present embodiment, the statistical processing unit 220 calculates the maximum value, minimum value, mean value, and standard deviation of sensor values included in each step. The statistical processing unit 220 sends processed data including the statistical values for each step to the exclusion unit 230.

In step S4, the exclusion unit 230 of the analysis apparatus 140 receives the trace data from the acquisition unit 210. Further, the exclusion unit 230 receives the processed data from the statistical processing unit 220. The exclusion unit 230 determines whether the variation range of sensor values included in the trace data satisfies a fixed value criterion. When the variation range of sensor values does not satisfy the fixed value criterion, the exclusion unit 230 excludes statistical values calculated based on the trace data from the processed data.

In step S5, the exclusion unit 230 of the analysis apparatus 140 determines whether the variation range of sensor values included in the trace data satisfies a minute variation criterion. When the variation range of sensor values does not satisfy the minute variation criterion, the exclusion unit 230 excludes statistical values calculated based on the trace data from the processed data.

The exclusion unit 230 stores the processed data in the data storage 240. Accordingly, the processed data stored in the data storage 240 contains only statistical values based on the trace data that satisfies the fixed value criterion and the minute variation criterion.

In step S6, the analysis unit 270 of the analysis apparatus 140 accepts an analysis request from the user. The analysis request contains information indicating an analysis and information indicating an analysis target. The information indicating the analysis target includes information indicating steps and sensors. The analysis unit 270 reads processed data about steps and sensors specified as the analysis target from the data storage 240. The analysis unit 270 sends the read processed data and the information indicating the analysis to the normalization unit 250.

In step S7, the normalization unit 250 of the analysis apparatus 140 receives the processed data and the information indicating the analysis from the analysis unit 270. When the analysis is equipment difference analysis, the normalization unit 250 normalizes the processed data using a normalization method specialized for equipment difference analysis. When the analysis is not equipment difference analysis, the normalization unit 250 normalizes the processed data. The normalization unit 250 sends the normalized processed data to the grouping unit 260.

In step S8, the grouping unit 260 of the analysis apparatus 140 receives the normalized processed data from the normalization unit 250. The grouping unit 260 groups a plurality of sensors provided in the substrate processing apparatus 120. The grouping unit 260 groups the normalized processed data based on sensor groups. The grouping unit 260 sends the grouped processed data to the analysis unit 270.

In step S9, the analysis unit 270 of the analysis apparatus 140 receives the processed data from the grouping unit 260. The analysis unit 270 analyzes the process executed by the substrate processing apparatus 120 based on the processed data and the analysis specified in the analysis request accepted in step S6.

When the analysis target specified in the analysis request is a sensor group, the analysis unit 270 calculates the representative value of statistical values for each group to analyze a variation within or between groups. The analysis unit 270 may construct a model used for an analysis based on the representative value of statistical values for each group.

In step S10, the analysis unit 270 of the analysis apparatus 140 outputs the analysis results of the process from step S9. Specifically, the analysis unit 270 displays the analysis results on the output device 502 connected to the analysis apparatus 140.

The user of the analysis apparatus 140 may verify the process executed by the substrate processing apparatus 120 by referring to the analysis results output from the analysis apparatus 140. The user of the analysis apparatus 140 may utilize the verification results for the design or operation of the substrate processing apparatus 120 or the process recipe.

### Effects of Embodiment

In the present embodiment, the analysis apparatus 140 calculates statistical values of sensor values for each step based on sensor data indicating the sensor values measured by sensors provided in the substrate processing apparatus that performs a process, and analyzes the process based on processed data including the statistical values for each step. In one aspect, according to the present embodiment, the computational load required for process analysis may be reduced since processed data may be reused in various analyses. Further, according to the present embodiment, the memory capacity required for process analysis may be reduced by retaining the statistical values for each step.

The analysis apparatus 140 may exclude sensor data when the variation range of sensor values included in the sensor data does not satisfy a predefined criterion. The criterion may indicate that the variation range is equal to or greater than a threshold obtained by multiplying the resolution of a sensor by a predefined coefficient. According to the present embodiment, sensor data that is unnecessary for analysis based on domain knowledge may be excluded.

The analysis apparatus 140 may analyze processed data using an analysis specified by the user. The analysis apparatus 140 may normalize processed data using a method corresponding to the analysis. When the analysis is equipment difference analysis, the analysis apparatus 140 may divide processed data by a normalization coefficient, which is the standard deviation converted from the weighted average of the variance of the processed data. According to the present embodiment, the processed data may be normalized using an appropriate method corresponding to the analysis.

The analysis apparatus 140 may classify a plurality of sensors provided in the substrate processing apparatus into a plurality of groups. The analysis apparatus 140 may analyze the process based on the representative value of statistical values of sensor values measured by sensors classified into groups. The analysis apparatus 140 may classify the sensors into groups based on the design information of the substrate processing apparatus or the correlation between processed data. According to the present embodiment, the process may be analyzed with a high accuracy and reduced computational load by analyzing a large number of sensors on a per-group basis.

### Modification

A process recipe executed by the substrate processing apparatus may include a plurality of iterations of processing. As an example, an atomic layer deposition (ALD) apparatus may execute a process recipe including a plurality of iterations. The process recipe including iterations of processing causes an increase in the computational load required for process analysis due to the enormous number of steps. Therefore, preprocessing trace data, obtained when performing a process including iterations of processing, with a minimal computational load may further reduce the computational load for process analysis.

In this modification, trace data including iterations of processing is divided into a plurality of segments, and statistical values are calculated on a per-segment basis. Each segment includes sensor values measured during one or more iterations of processing. At this time, a segment closer to the beginning of the trace data includes sensor values measured from a smaller number of iterations (e.g., one), while a segment closer to the end of the trace data includes sensor values measured from a larger number of iterations (e.g., two or more).

Specifically, for the first to the N^{th} iterations of processing in the trace data, one iteration is included in one segment, while the (N+1)^{th} and subsequent iterations are divided into M segments. When there is any remainer when divided into M segments, it may be added to the last segment. This allows the trace data to be divided into N+M segments.

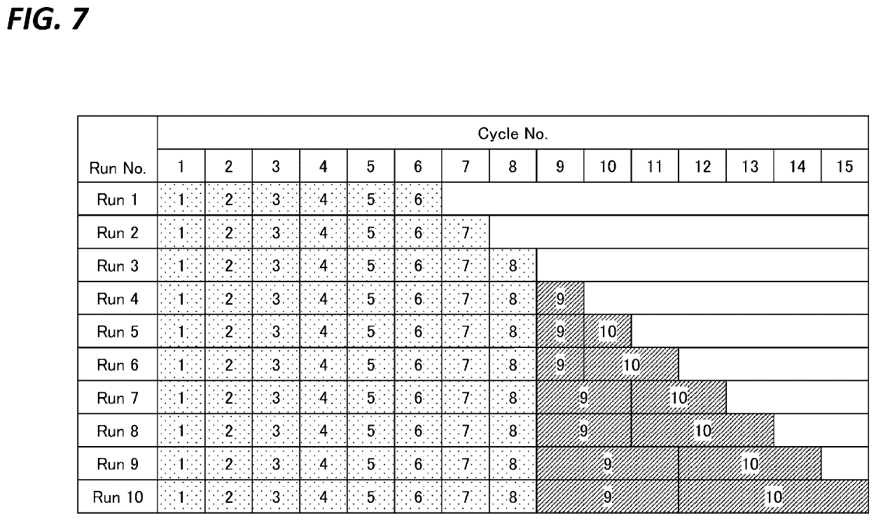

FIG. 7 is a diagram illustrating an example of segmentation. FIG. 7 illustrates an example in which 10 processes (Run 1 to Run 10) with different iteration cycles are segmented respectively. In FIG. 7, N is 8 and M is 2.

As illustrated in FIG. 7, for processes (Run 1 to Run 3) with iteration cycles that are less than or equal to N, each iteration is included in one segment (1 to N). For processes (Run 4 to Run 10) with iteration cycles that are greater than or equal to N+1, the number of iterations divided by M after subtracting N from the iteration cycles are included in segments 9 and 10. For example, for Run 10 with 15 iteration cycles, segment 9 includes 3 ((15-8)/2) iterations, and segment 10 includes 4 ((15-8)/2+1) iterations.

The statistical processing unit 220 calculates statistical values for each segment. For a segment including a single iteration, the statistical processing unit 220 calculates statistical values for each step, as in the embodiment. Meanwhile, for a segment including a plurality of a plurality of iterations, the statistical processing unit 220 calculates statistical values by aggregating the same steps executed during the plurality of iterations.

According to the modification, even for trace data when performing a process including a large number of iterations, statistical values included in processed data may be kept at a fixed number (e.g., N+M) or less. As a result, even a process including a large number of iterations may be analyzed based on processed data including a fixed number of statistical values or fewer, which further reduces a computational load required for process analysis.

### OTHER EMBODIMENTS

A substrate processing apparatus that executes a process including a substrate processing method of the present disclosure is not limited to a heat treatment apparatus. The substrate processing apparatus may be applied to any type of apparatuses such as atomic layer deposition (ALD), capacitively coupled plasma (CCP), inductively coupled plasma (ICP), radial line slot antenna (RLSA), electron cyclotron resonance plasma (ECR), and helicon wave plasma (HWP) apparatuses.

Further, the substrate processing apparatus of the present disclosure may be applied to apparatuses that perform predetermined processing (e.g., film formation or etching) on a substrate, whether the apparatuses use plasma or not. Further, the substrate processing apparatus of the present disclosure may also be applied to different types of apparatuses, such as a single wafer processing apparatus that processes substrates one at a time, a batch processing apparatus that processes a plurality of substrates at once, and a semi-batch processing apparatus that processes fewer substrates than the number handled in a batch processing apparatus.

In one aspect, the computational load required for process analysis may be reduced.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
acquisition circuitry configured to acquire sensor data indicating a sensor value measured by one or more sensors provided in a substrate processing apparatus that performs a process including one or more steps;
statistical processing circuitry configured to calculate a statistical value of the sensor value for each step based on the sensor data; and
analysis circuitry configured to analyze the process based on processed data including the statistical value for each step.

2. The information processing apparatus according to claim 1, further comprising:
exclusion circuitry configured to exclude the sensor data when a variation range of the sensor value included in the sensor data does not satisfy a criterion determined in advance.

3. The information processing apparatus according to claim 2, wherein the criterion indicates that the variation range is greater than or equal to a threshold obtained by multiplying a resolution of the sensor by a coefficient determined in advance.

4. The information processing apparatus according to claim 1, wherein the analysis circuitry are configured to analyze the processed data based on an analysis specified by a user.

5. The information processing apparatus according to claim 4, further comprising:
normalization circuitry configured to normalize the processed data using a method corresponding to the analysis.

6. The information processing apparatus according to claim 5, wherein the normalization circuitry are configured to divide the processed data by a normalization coefficient obtained by converting a weighted average of a variance of the processed data into a standard deviation, when the analysis is equipment difference analysis.

7. The information processing apparatus according to claim 4, further comprising:
grouping circuitry configured to classify a plurality of sensors provided in the substrate processing apparatus into a plurality of groups,
wherein the analysis circuitry are configured to analyze the process based on a representative value of the statistical value of the sensor value measured by the plurality of sensors classified into the plurality of groups.

8. The information processing apparatus according to claim 7, wherein the grouping circuitry is configured to classify the plurality of sensors into the plurality of groups based on design information of the substrate processing apparatus or a correlation between the processed data.

9. The information processing apparatus according to claim 1, wherein the statistical processing circuitry are configured to calculate the statistical value of the sensor value measured in a plurality of steps included in an iteration when the process includes the iteration.

10. An information processing method comprising:
acquiring, by a processor, sensor data indicating a sensor value measured by one or more sensors provided in a substrate processing apparatus that performs a process including one or more steps;
calculating, by the processor, a statistical value of the sensor value for each step based on the sensor data; and
analyzing, by the processor, the process based on processed data including the statistical value for each step.

11. A non-transitory computer-readable storage medium having stored therein a program that causes a computer to execute a process comprising:
acquiring sensor data indicating a sensor value measured by one or more sensors provided in a substrate processing apparatus that performs a process including one or more steps;
calculating a statistical value of the sensor value for each step based on the sensor data; and
analyzing the process based on processed data including the statistical value for each step.
